(19) United States
(12) Patent Application Publication
(10) Pub. No.: US 2008/0026733 A1
(43) Pub. Date: Jan. 31, 2008

(54) Method and system for improving positioning accuracy in cellular networks

(76) Inventor: Jussi Jaatinen, Helsinki (FI)

Correspondence Address: Hollingsworth & Funk, LLC;Suite 125, 8009 34th Avenue South, Minneapolis, MN, 55425, US

(21) Appl. No.: 11/494,677

(22) Filed: Jul. 27, 2006

(51) Int. Cl. H04M 3/42

(52) U.S. Cl. 455/414.2

(57) ABSTRACT

Systems and methods for improving the accuracy of positioning methods based on the available infrastructure of a cellular network or cellular networks. One aspect involves establishing a radio link between a mobile terminal and at least one fixed transceiver of a cellular network. At least two position estimates are acquired for the current position of the mobile terminal on at least two different frequencies, and an averaged position value is calculated from the at least two position estimates.

### FIELD OF THE INVENTION

This invention pertains to the positioning of mobile devices, and in particular to improving the accuracy of positioning methods based only on the available infrastructure of a cellular network or cellular networks.

### BACKGROUND

Mobile communication is usually implemented in the form of cellular radio networks. These networks are made up of a number of cells, wherein a cell is defined by a geographical area where communications are directed to and from fixed transceivers referred to as base stations. Mobile terminals moving around may be served by one or more base station which provide radio coverage for the area the terminal is currently located in.

Many applications of mobile devices may benefit from the ability to determine the current position of the mobile device. Navigating functionality may be included into mobile terminals, such as listings of available services in the area or guidance to a specific location. Another very important area of application is emergency positioning, such that emergency services are able to locate the mobile terminal and thus the caller of an emergency call with the highest possible accuracy. In some countries, mobile network operators are legally obligated to provide sufficient positioning in case of an emergency call.

There are various positioning schemes known in the art. Sometimes, these are divided into self-positioning methods and remote positioning methods. Self-positioning refers to the positioning of a receiver where the receiver itself makes measurements of signals from one or several transmitters to determine its position. The satellite based Global Positioning System (GPS) is an well-known example for a self-positioning system. Remote positioning methods are based on receivers at one or more locations measuring a signal that originates from the object to be positioned. Measurements from several locations, such as several base stations, may then be used at some central site or system to determine the desired position.

Most positioning techniques are applicable to any arbitrary cellular system. They are based on e.g. propagation time measurements, angle of arrival measurements, a combination of these measurements, or time difference of arrival measurements. Some of these methods will be discussed in more detail below.

Since all of these methods, as well as any further positioning methods not mentioned here, have limited accuracy, some mobile devices are additionally provided with satellite based positioning systems such as GPS to improve positioning capabilities. While this is helpful for positioning purposes, it leads to considerably higher production cost and a more complicated implementation of the mobile system. Nevertheless, this option is applied to some extent as there are e.g. requirements to enable exact mobile radio positioning for emergency purposes.

Therefore, there is a desire for positioning methods with improved accuracy that can be implemented by means of existing radio network infrastructure with low cost and limited effort.

### SUMMARY

The invention provides various embodiments to improve the accuracy of radio positioning by exploiting the fact that many errors and limiting effects are dependent on the frequency of the positioning measurement signals.

This may be achieved by a method comprising establishing a radio link between a mobile terminal and at least one fixed transceiver of a cellular network; acquiring at least two position estimates for the current position of said mobile terminal on at least two different frequencies; and calculating an averaged position value from said at least two position estimates or calculating an improved position value as a function of said at least two position estimates.

The acquiring of a position estimate may include receiving at least one position estimate via said radio link.

In certain embodiments, said acquiring of a position estimate includes receiving at least one signal on at least one frequency, and determining one or more parameters of said at least one received signals.

Furthermore said acquiring of a position estimate may include calculating a distance between said mobile terminal and said at least one transceiver based on said determined signal parameters.

In one embodiment, said acquiring of position estimates may include said mobile terminal receiving a first signal on a first frequency; said mobile terminal performing a handover from said first frequency to a second frequency; and said mobile terminal receiving a second signal on said second frequency.

The handover may be a inter-frequency handover, a inter-operator handover, a inter-mode handover or a inter-radio access technology handover.

Optionally, signals may be received on more than two different frequencies, performing at least two subsequent handovers.

In one embodiment, wherein a code division multiple access system is used for said radio link, said acquiring of position estimates includes said mobile terminal entering compressed mode; said mobile terminal receiving a first signal on said first frequency; and said mobile terminal receiving at least one second signal in at least one transmission gap on said second frequency.

In one embodiment, wherein a time division multiple access scheme is used for said radio link, said acquiring of position estimates may include receiving a first signal on a first frequency in a time slot allocated for signal reception; and receiving at least one second signal on a second frequency in an unallocated time slot.

In another embodiment wherein said mobile terminal has at least two receivers, said mobile terminal may receive at least two signals on at least two different frequencies essentially simultaneously via said two receivers.

In all embodiments, said averaged position value may optionally be calculated using a mathematical algorithm or function, the inputs of which are parameters of signals and/or signal components received on at least two frequencies by at least one receiver, and optionally quality information relating to said signals and/or signal components, and the output is at least one position estimate. This algorithm may, for example, weight the direction-of arrival estimates of multipath radio signals from different frequencies according to their signal strength before averaging them. In another algorithmic embodiment, the algorithm may assign signal components from various frequencies to clusters and derive direction of arrival and/or position estimates to said clusters, optionally feeding these cluster estimates to a further algorithm or function as signal components to derive at least one position estimate. Also combinations of various forms of the foregoing embodiments can be used to produce position estimates.

According to a further embodiment of the invention, a method is provided comprising: establishing a radio link between a mobile terminal and at least one fixed transceiver of a cellular network, transmitting a first signal suitable for position measurements on a first frequency, and transmitting a second signal suitable for position measurements on a second frequency.

Optionally, at least one further signal suitable for position measurements may be transmitted on at least one further frequency.

In one embodiment of the invention, said mobile terminal performs said steps of transmitting a first and second signal, and the provided method may further comprise said mobile terminal performing a handover from said first frequency to said second frequency upon transmitting said first signal.

The handover may for example be a inter-frequency handover, a inter-operator handover, a inter-mode handover or a inter-radio access technology handover.

According to one embodiment of the invention, signals are transmitted on more than two different frequencies, and at least two subsequent handovers between at least three frequencies are performed.

In one embodiment of the invention, a code division multiple access system is used for said radio link, and said mobile terminal performs said steps of transmitting first and second signals, such that said mobile terminal enters compressed mode and said mobile terminal transmits said at least one second signal in at least one transmission gap on said second frequency.

In a further embodiment of the invention, wherein a time division multiple access scheme is used for said radio link, said first signal is transmitted in an time slot allocated for signal transmission, and said at least one second signal is transmitted in an unallocated time slot.

According to another aspect of the invention, a method is provided comprising: establishing a radio link between a mobile terminal and at least one fixed transceiver of a cellular network; transmitting a first signal suitable for position measurements on a first frequency; receiving a second signal suitable for position measurements on a second frequency; and deriving a second position estimate from measured parameters of said second signal.

Optionally, the derived second position estimate may be transmitted to another device.

Furthermore, at least one position estimate based on said transmitted first signal may be received or derived from measured parameters of said first signal.

According to one embodiment of the invention, an averaged position estimate may be calculated from said derived second position estimate and said at least one received position estimate. In a generalized embodiment, any number of signals may be received, their parameters measures and used to derive a plurality of position estimates, which may then be averaged to produce a final position estimate.

In one embodiment of the invention, wherein a code division multiple access system is used for said radio link, the method further comprises entering compressed mode for said radio link, and transmitting or receiving said first or second signal during a transmission gap of said compressed mode.

In another embodiment of the invention, wherein a time division multiple access scheme is used for said radio link, said first or second signal may be received or transmitted, respectively, in an unallocated time slot.

In a further embodiment of the invention, a frequency division duplex mode may be employed for uplink and downlink communication on said radio link. In this embodiment the invention may comprise the mobile station producing a position estimate of itself by self-positioning using the downlink signals from base stations currently in communication with said mobile station, said mobile station transmitting said estimate to the network and the network using this position estimate as one component when deriving a final position estimate according to embodiments of the invention.

According to a further aspect of the invention, a device is provided that comprises means for acquiring a first position estimate for a mobile terminal on a first frequency, means for acquiring a second position estimate for said mobile terminal on a second frequency, and means for calculating an averaged position value from said position estimates. This device may be a base station, a mobile terminal, a network controller or some other network element of a cellular network.

According to another aspect of the invention, a system is provided that comprises at least one base transceiver station of a cellular network; a mobile terminal adapted for transmitting and/or receiving signals on at least two different frequencies; processing means for determining a position based on measured signal parameters; and averaging means for calculating an averaged position value from at least two position estimates.

Said averaging means may be located at e.g. a network controller, a mobile switching center, or a base station controller. Alternatively or additionally, said averaging means is included in the mobile terminal and/or in one of the base stations.

The mobile terminal may be a dual mode terminal capable of operating in both a CDMA based system and a TDMA based system.

### BRIEF DESCRIPTION OF THE DRAWINGS

In the following, various embodiments and aspects of the invention will be described in more detail with reference to the enclosed figures, where:

FIG. 1 is a schematic view of a cellular communication network (1a) and a mobile terminal (1b) that may be used for the method of the invention;

FIG. 2a-2d are illustrations of exemplary cellular positioning schemes;

FIG. 3a shows signal workflows in a remote positioning embodiment of the invention;

FIG. 3b is a similar illustration for a self-positioning embodiment of the invention;

FIG. 3c is another illustration for a combined remote and self-positioning embodiment of the invention;

FIG. 4 is a flow chart including method steps of the inventive embodiment of FIG. 3a for various implementations;

FIG. 5 shows the use of compressed mode for positioning measurements according to an exemplary embodiment of the invention;

FIG. 6 illustrates the use of handovers for positioning measurements according to another embodiment of the invention;

FIG. 7 shows the use of unallocated time slots for positioning measurements according to another embodiment of the invention;

FIG. 8 is a flow chart showing method steps of the inventive embodiment of FIG. 3b; and

FIG. 9 is a flow chart showing method steps of the inventive embodiment of FIG. 3c.

### DETAILED DESCRIPTION OF EXEMPLARY EMBODIMENTS

While the invention will be disclosed in connection with certain embodiments, it shall be understood that it is not intended to limit the invention to these embodiments. On the contrary, it is intended to cover all alternatives, modifications, combinations and equivalents that may be included within the spirit and scope of the invention as defined by the appended claims.

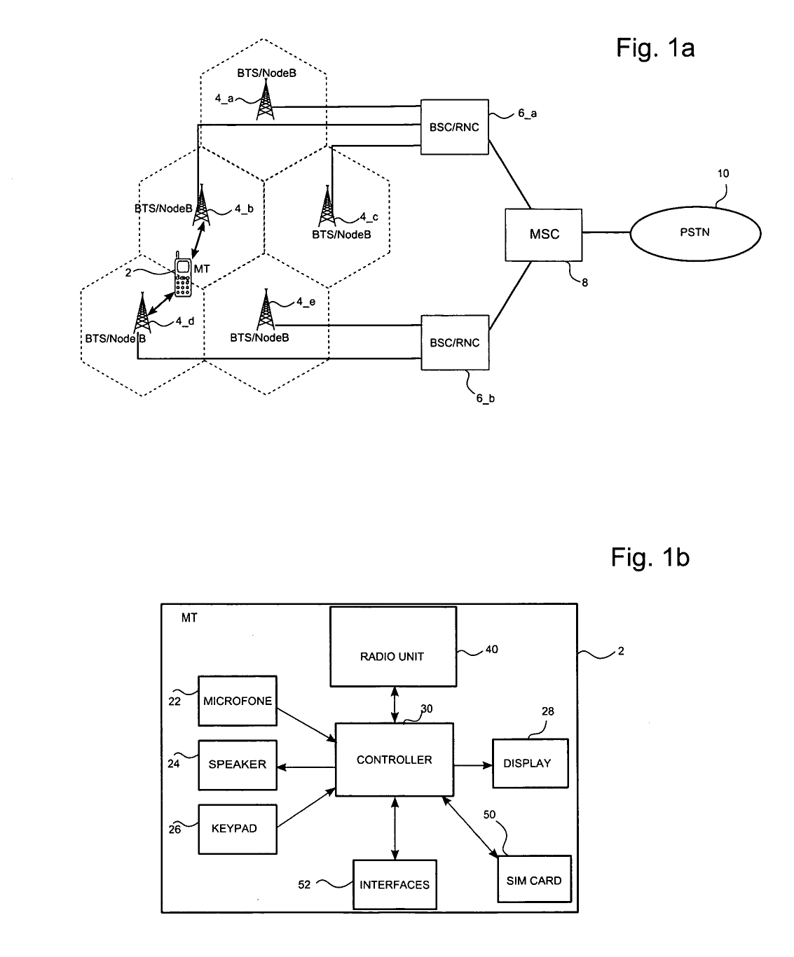

Cellular communication systems are widespread around the world. As shown in general in FIG. 1a, such a system comprises several mobile terminals 2, such as a mobile station or user equipment, which are capable of radio communication with fixed base transceiver stations 4 (e.g. base stations or node B) of one or more networks. One or more base transceiver stations 2 are connected to a controller 6 (e.g. a base station controller or a radio network controller), which may for example control handovers, radio connections, and power allocation. Several base transceiver stations are connected to one mobile switching center 8 which serves as an interface between the base station subsystem/access network and the public switch telephone network 10 (or other mobile networks). Additional network elements which are not shown here, such as location registers, GPRS support nodes or authentication centers, are usually also included in a cellular network, as is known to one skilled in the art.

The basic operating principles for signalling between mobile terminals 2 and base transceiver stations 4/cell sites vary. An important aspect is the manner how different signals between various transmitters and receivers are distinguished and how bandwidth is shared. Common solutions to this are frequency division multiple access (FDMA), time division multiple access (TDMA) and code division multiple access (CDMA). In FDMA, the available radio frequency bandwidth is divided into smaller frequency bands, with each of these bands assigned to one of the transmitters. A mobile terminal 2 then uses a specific frequency for communication with a chosen cell. The principle of CDMA is more complex, but achieves the same result; all transmitted data is encoded by a code specific to a transmitter that is then used to distinguish the various signals, which may all be transmitted on the same frequency band. TDMA divides channels into time periods, usually referred to as time slots, which are then assigned to the transmitters such that on a certain channel/frequency only one transmission per time slot is present.

These multiple access schemes may also be combined. For example, the second generation mobile communication system GSM (Global System for Mobile communications) employs FDMA for using the available frequency bandwidth, and also TDMA to divide each frequency band into time slots. In GSM-900, the frequency band of 890-915 MHz is used to send data from mobile terminals to the base station (uplink), and 935-960 MHz for the opposite direction (downlink). Other GSM systems with different frequency bands exist, with some examples shown in table 1 below. Each of these frequency bands of GSM 900 is divided in 124 channels in intervals of 200 kHz. Each of the channels contains 8 TDMA channels, that is, eight time slots with a length of 576.9 μs, which add up to one TDMA frame.

TABLE 1

| | Uplink RF | Downlink RF |
|---|---|---|
| System | Band [MHz] | Band [MHz] |
| GSM 900 (Europe): | 890–915 | 935–960 |
| GSM 1800 (Europe): | 1710–1785 | 1805–1880 |
| GSM 850 (USA): | 824–849 | 869–894 |
| GSM 1900 (USA): | 1850–1910 | 1930–1990 |
| cdma2000 (USA): | 1850–1910 | 1930–1990 |
| WCDMA 2100 (Europe): | 1920–1980 | 2110–2170 |

Referring to third generation WCDMA (Wideband Code Division Multiple Access) systems as an example, a different concept is used. As indicated by the name, CDMA is used for allocating radio resources. In addition, uplink and downlink are separated by using separate 5 MHz carrier frequencies for uplink and downlink respectively in FDD mode, and by time division in TDD (time division duplex) mode.

The details given here for the GSM and WCDMA systems are only mentioned as examples for allocating available bandwidth, and the invention is not limited to the systems mentioned above. Other systems may use different allocations, access schemes and concepts. Also, any terms used are not limited to any specific system or technology. For example, the term base station or base transceiver station will be used throughout this description to refer to a GSM base station as well as a UMTS (Universal Mobile Telecommunications System) Node B or any other base transceiver station 4 of a cellular network.

With reference to FIG. 1b, a mobile terminal that may be used for implementing the method of the invention in general comprises at least a radio unit 40, a user interface, a controller 30 and a power source (not shown). The user interface may have a microphone 22 and speaker 24 for voice communication, as well as a display 28 and various kinds of input means 26, such as a keypad, scroll key, keyboard, touch screen or any other type. Further interfaces 52 for data communication may be included in the mobile terminal, such as USB, serial interfaces, wireless interfaces (e.g. Bluetooth or WLAN) and many more. In many terminals, a processor (not shown) is included for data processing and providing further applications, as well as volatile and/or non-volatile memory elements. A SIM-card 50 and a corresponding SIM-card reader are typically used for authentication and identification purposes in a network. A mobile terminal 2 may furthermore be adapted for transmitting voice, data, multimedia content, text, and/or further types of data.

The radio unit 40 includes at least one radio transceiver and at least one antenna, which may be suited for use at a single or at multiple frequencies. For implementing the invention, the mobile terminal needs to be capable to operate on at least two different frequencies, simultaneously and/or successively. Frequency band-pass filters (not shown) may be included into the signal path between antenna and the radio subsystem to separate RF signals received by the antenna such that frequencies of different frequency bands are supplied to the respective receiver/transceiver subsystem in accordance with the corresponding radio frequency bands.

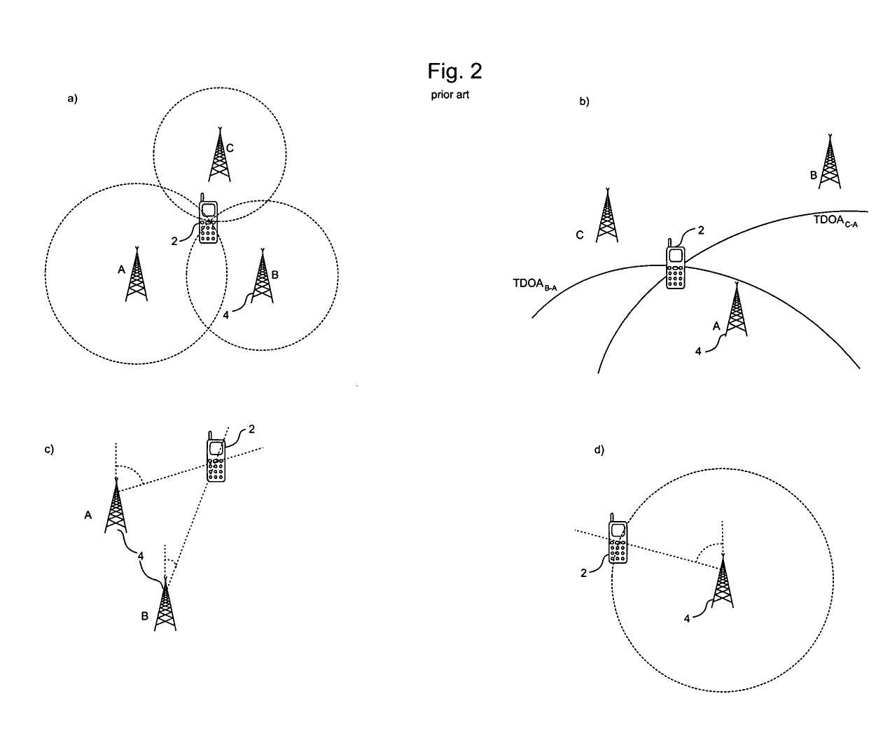

FIG. 2 illustrates some basic positioning techniques for cellular networks. In FIG. 2a, a propagation time measurement is demonstrated, using three base stations or fixed transceivers 4 A, B and C within the signalling range of a mobile terminal 2. As suggested by the name of this technique, it involves measuring the time it takes for a signal to travel between a fixed transceiver and a mobile terminal or the other way around. In a similar way, the propagation round-time of a signal transmitted from a source and reflected back to the source may be measured. The determined propagation time defines a circular locus around each of the involved transceivers since the propagation velocity of the radio signal in normal atmosphere is known. While two transceivers would still give an ambiguous position result, showing two intersection points of the circles, a third measurement resolves this ambiguity and indicates the position of the mobile terminal at the only intersection point of all three propagation time circles.

A similar approach is used in time difference of arrival (TDOA) methods as shown in FIG. 2b. Instead of absolute propagation times, the time difference between arrivals of two signals is determined. This implies that some kind of synchronization within the system is necessary to avoid bias errors. The signals could either be transmitted by several fixed transceivers 4, with the mobile terminal 2 “listening” to the signals as a receiver and determining the time differences of arrivals (self-positioning approach); or the mobile terminal 2 could transmit signals that are received by several fixed transceivers 4, resulting in time of arrival values that are then sent to a central site to derive the desired time differences (remote positioning). For example, a network controller 6 of a cellular network may serve as such a central site. The time differences result in hyperbolic loci around the transceivers 4, and their intersection point defines the position of the mobile terminal 2. With three transceivers A, B, C as shown in FIG. 2b that are used in a self-positioning approach here, serving as transmitters of the used signals, two hyperbolics are obtained, denoted by TDOA_{C-A} for the time difference of arrived signals at transceivers C and A, and TDOA_{B-A} for the time difference of arrived signals at transceivers B and A.

FIG. 2c shows a method that only requires two fixed transceivers 4. The mobile terminal 2 is located by determined angles of arrivals (AOA). The signals for determining angles may be transmitted from the mobile terminal 2 to two fixed transceivers 4, or from the transceivers 4 to the mobile terminal 2. In either way, an unambiguous intersection point of two straight lines is obtained, and again the intersection point determines the mobile terminal's 2 position.

By combining this angle of arrival determination with propagation time measurements, a single base station 4 may be sufficient to determine the location of a terminal 2. It is irrelevant which of both elements serves as transmitter or receiver of the measuring signal. This approach is illustrated in FIG. 2d.

A further method that may be employed alone or in combination with other measurements is determination of the carrier phase of a received signal. Also, signal strength measurements may provide further information to resolve ambiguities. There are, however, many more schemes and techniques for acquiring location information in various radio networks, and the above techniques are only mentioned by way of example. Any positioning techniques may be combined and averaged according to various embodiments of the invention, as long as their coordinate mapping is similar or may be brought into accordance. Thus, the method of the invention is independent of the specific positioning methods used for obtaining the position estimates. The values used to create an averaged position value may also be determined by several different positioning techniques on multiple frequencies.

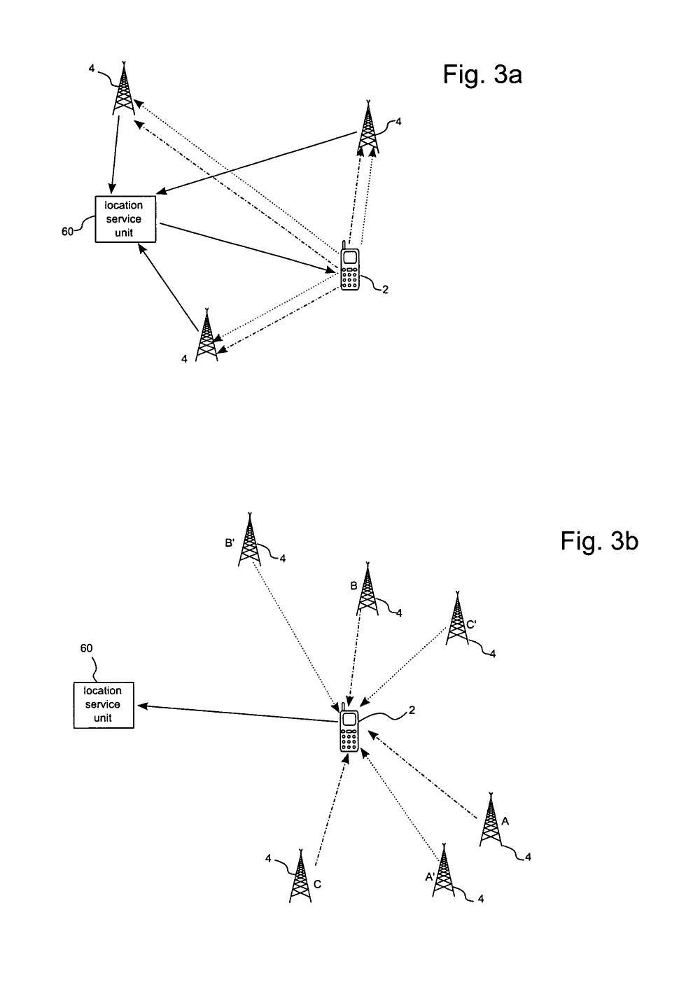

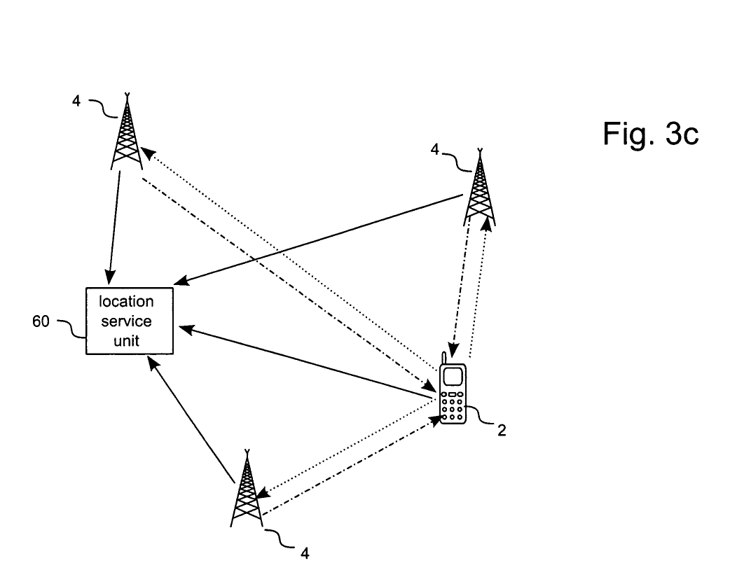

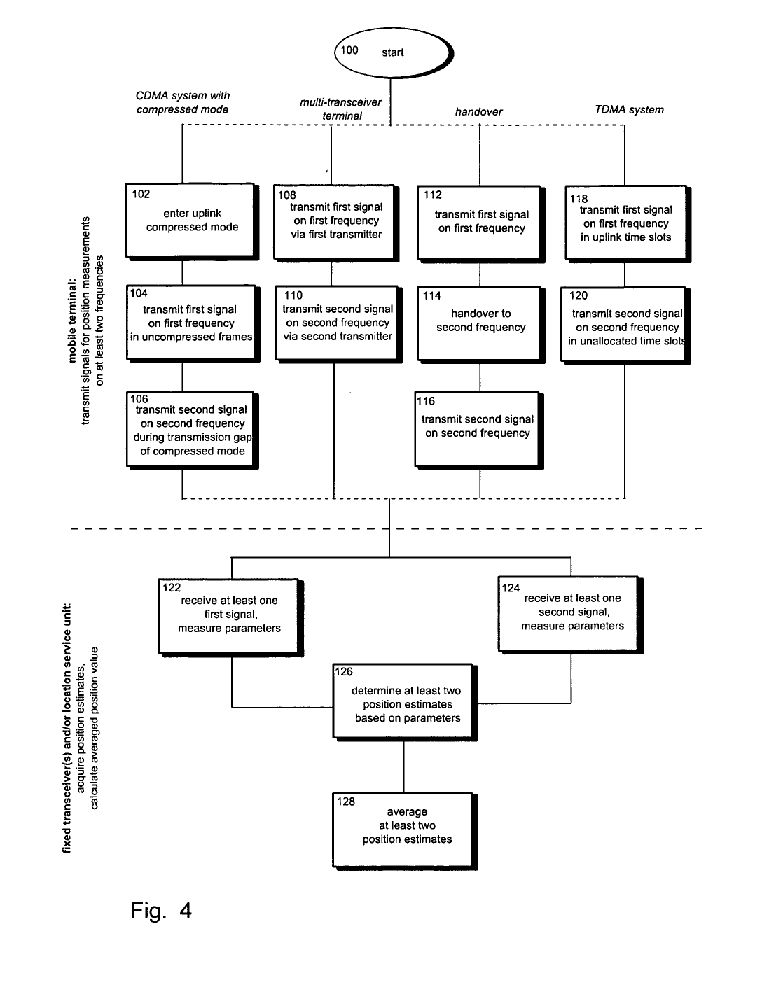

FIG. 3a illustrates a first possibility for implementing the invention, with corresponding method steps shown in FIG. 4. A radio link is established between a mobile terminal 2 and at least one fixed transceiver 4. In some cases, a mobile terminal 2 may have a connection to more than one fixed transceivers or base stations 4, such as in soft handover situations of WCDMA systems. As described above, the position of a mobile terminal 2 within a cellular network may be determined by means of one or more base stations 4 of the network, depending on the positioning scheme that is used. The mobile terminal 2 the position of which should be determined may transmit a signal at a first frequency (in steps 104, 108, 112, or 118, respectively, of FIG. 4), which is indicated by the dotted arrow in FIG. 3. This first frequency could be the current operating frequency on which the mobile terminal 2 communicates. Subsequently or simultaneously it may transmit a second signal (shown as a dashed-dotted arrow) at a second frequency (steps 106, 110, 116, 120, respectively), and optionally also further signals at one of these two frequencies or at additional frequencies (not shown). FIG. 4 shows several different possibilities for a mobile terminal 2 to effect transmission of signals on at least two different frequencies, which will be discussed in more detail below. Since the mobile terminal 2 sends signals that are received by a base station 4 or some other receiver which may then determine the terminal's position, this example in FIG. 3a employs a remote positioning scheme.

The signals transmitted on at least two frequencies are received by one or more base stations 4 of the cellular network(s) in step 122 and 124. At least one parameter suitable for positioning may be measured from the received signal. This may be e.g. the time of arrival, signal strength, signal phase, angle of arrival, propagation time, or some other parameter. For positioning schemes that may be employed with a single base station, a position estimate may now be derived from these parameters in step 126. If the same base station 4 received more than one positioning signal at different frequencies, it may derive all position estimates for different frequencies and then average these to obtain an averaged position value in step 128. This might be the case for a base station that serves more than one operating frequency or even more than one radio access technology (RAT). If only signals at one frequency were received, the respective measurement results or optionally the position estimates derived from these measurements have to be combined at a central site. This may be a location service unit 60 (FIG. 3a), which could be integrated by means of hardware or software into another network element, such as a radio network controller 6, base station controller 6, mobile switching center 8 or similar elements which have connections to several base stations 4. At this location service unit 60, positions may be derived from all measurement results at each frequency if this was not done before by a base station (alternative step 128). Subsequently, all acquired position estimates based on signals at two or more different frequencies are averaged. It is not important for the method of the invention at which network element the averaging of all acquired position estimates is performed. The resultant averaged position value will mitigate many frequency dependent errors and undesired effects and thus have increased accuracy compared to the single position estimates derived at only one frequency. In addition to averaging, any of a range of more elaborate data combining algorithms may be used on either the position estimates derived at different frequencies, systems or base stations, or the component data these estimate derivations use.

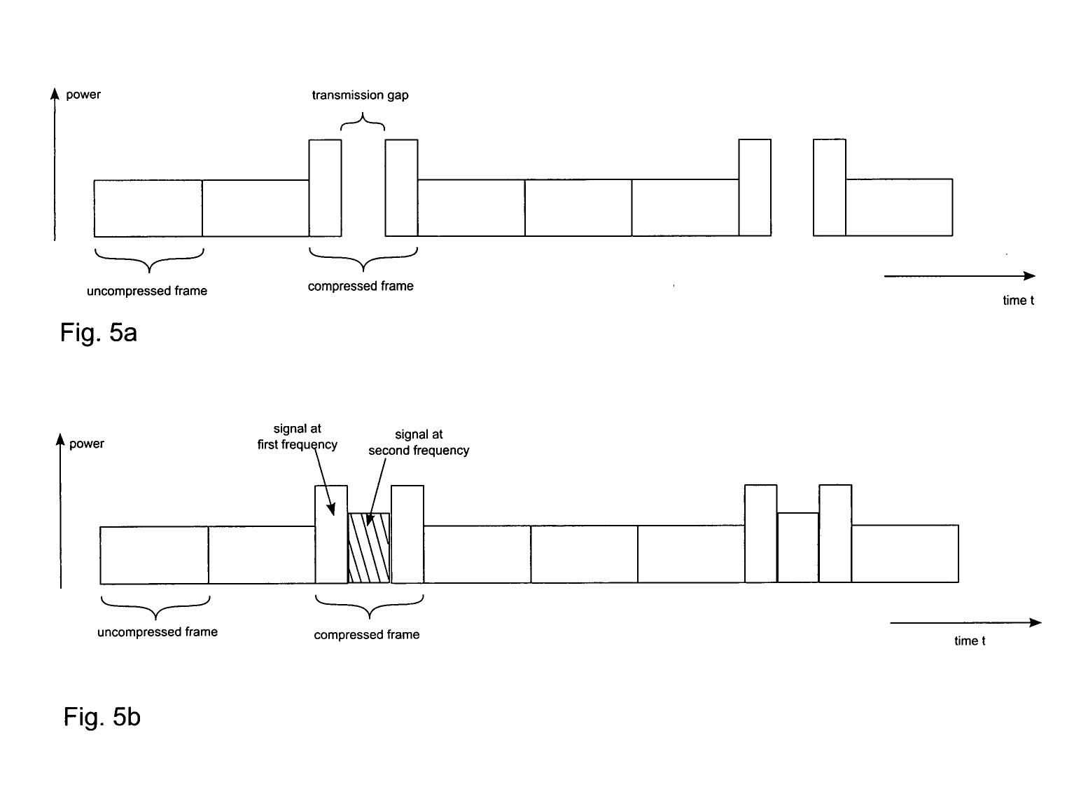

A first possibility to achieve positioning on different frequencies for CDMA based systems, such as UMTS or cdma2000, is the use of compressed mode (also referred to as slotted mode). As mentioned above, handovers to different frequencies, cells or systems usually require antecedent measurements to determine the quality of various handover candidate links. In CDMA based systems, transmission and reception of data is basically continuous. For making measurements on different candidate frequencies, where a mobile terminal needs to quickly tune its transceiver (or one of its transceivers) to other frequencies, it is therefore necessary to find suitable time intervals to perform those measurements without interfering with the normal operation of the mobile terminal. Compressed mode provides such time intervals by generating transmission gaps in downlink and/or uplink frames, which is shown in FIG. 5. Data to be transmitted within the respective frames is compressed to avoid data loss. As known to one skilled in the art, this compression may be achieved in various manners; the data rate from higher layers may be lowered, the spreading factor may be decreased, or the amount of data may be reduced by puncturing bits. Compressed frames in uplink and downlink may be provided simultaneously to reduce interference.

Instead of using the transmission gaps for handover measurements as known in the art, they may according to one embodiment of the invention be used for positioning measurements. In the embodiment of FIG. 3a, a first signal is transmitted by the mobile terminal at a first frequency (step 104 of FIG. 4), which would be the current operating frequency of the mobile terminal. By entering compressed mode in step 102 before or after transmitting the first signal, transmission gaps in (at least) the uplink are generated which may now be used to tune to a second frequency and transmit a second signal at that frequency in step 106. Both signals may either be transmitted to a certain base station or as a broadcast signal. For example, the mobile terminal might be operating in the WCDMA system with a uplink frequency band at 1950 MHz, where the first signal is transmitted, and then transmit second signals on a uplink frequency band of a GSM-850 system. The base station may use existing WCDMA delay profile information to find the mobile terminal's uplink GSM transmissions in synchronization space and perform position estimation simultaneously on WCDMA and GSM bands. Alternatively, measurements on a different frequency of the same UMTS system may be possible. Increased accuracy for the averaged position value may be obtained by using more than two frequencies, and/or by optionally combining several different positioning methods on these different frequencies. To this end, a pattern of several transmission gaps may be used to transmit signals on three or even more frequencies within a relatively short time period.

This embodiment using compressed mode for positioning purposes provides essentially simultaneous signal measurements and position estimates on various frequencies, which will then be averaged by any network element to obtain an averaged position value. Thus, also moving mobile terminals may be located with high accuracy. Additional oscillators for frequency generation may be provided, as well as other duplicated components, to ensure that the mobile terminal is capable of tuning to a different frequency within one frame having a length of 10 ms in e.g. WCDMA.

Another exemplary embodiment of the invention is based on handovers to different frequencies. After a first signal for positioning purposes was transmitted on a first frequency in step 112, again usually the current operating frequency, the connection is handed over to a different frequency (step 114). Upon this, a second positioning signal on this second frequency may be transmitted in step 116 without the need for compressed mode. After the second signal has been transmitted, the connection may be maintained on this frequency, or alternatively another handover back to the previous frequency or to a further third frequency may be performed. Additional position estimates may be obtained by using subsequent handovers between more than two different frequencies. The employed handovers may be any kind of handover that involves a change of operating frequency. Thus, not only inter-frequency handovers are possible, which are usually defined as handovers between two frequency carriers of the same base station or different base stations, but also inter-system, inter-operator and inter-RAT handovers, as different access technologies and different systems in general employ different operating frequencies. The chosen handover type may be dependent on the operating capabilities of the mobile terminal, the available coverage, and further considerations such as expected signal performance. For example, most mobile terminals for UMTS systems are also capable of operating in one or more GSM systems and are thus referred to as “dual-mode” or “multi-mode” terminals. Also, many GSM mobile terminals are available for operation on two or three frequency bands (dual-band or tri-band terminals), to allow communication in all of the prevalent GSM systems with a single device. Blind handovers may be employed, that is, handovers without any previous handover measurements performed. This is especially suitable when it is already known that another frequency or system is available for handover to avoid unnecessary handover signalling and accelerate the positioning process.

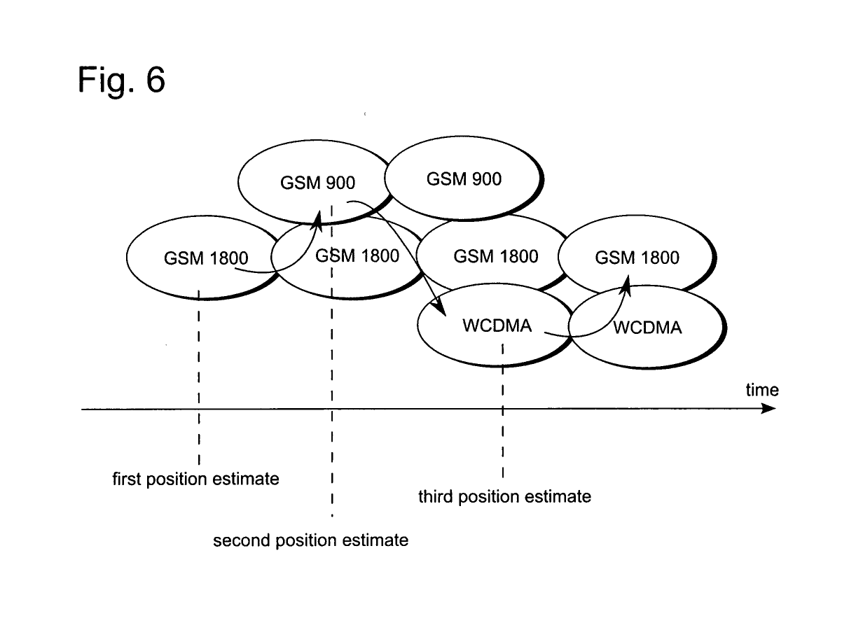

FIG. 6 shows an example for using handovers to derive three subsequent position estimates. The initial operating mode is GSM 1800 in this example, and a first position estimate is acquired by self or remote positioning on this frequency. Then, a handover to e.g. GSM 900 is initiated, indicated by the arrow in FIG. 6. As the operating frequency is now different from before, a second position estimate on a different frequency can now be acquired. Optionally, a further position estimate may be acquired after performing another handover to WCDMA when coverage is available. The used handover types, frequencies and operating modes are only used by way of example and may be substituted by any other handover, operating mode or network within the scope of this invention.

As handovers would take slightly more time than compressed mode measurements, the position estimates on the different frequencies would not be exactly simultaneous. While this may cause errors for the averaged position value in the case of a fast-moving mobile terminal, the improved accuracy obtained by the averaging will in most cases still exceed these errors. Furthermore, such error effects may be estimated and mitigated by using additional error correction algorithms which might for example apply measured Doppler shifts to eliminate the error introduced by the movement. Also, if e.g. three frequencies are used and the results would indicate a moving mobile terminal, the effects of movement on the position estimate may easily be removed, and it would even be possible to predict a terminal's position ahead in time based on the previous measurements. It is an important aspect of the handover based embodiment that no essential changes to the network or terminal functions are necessary to implement the method of the invention.

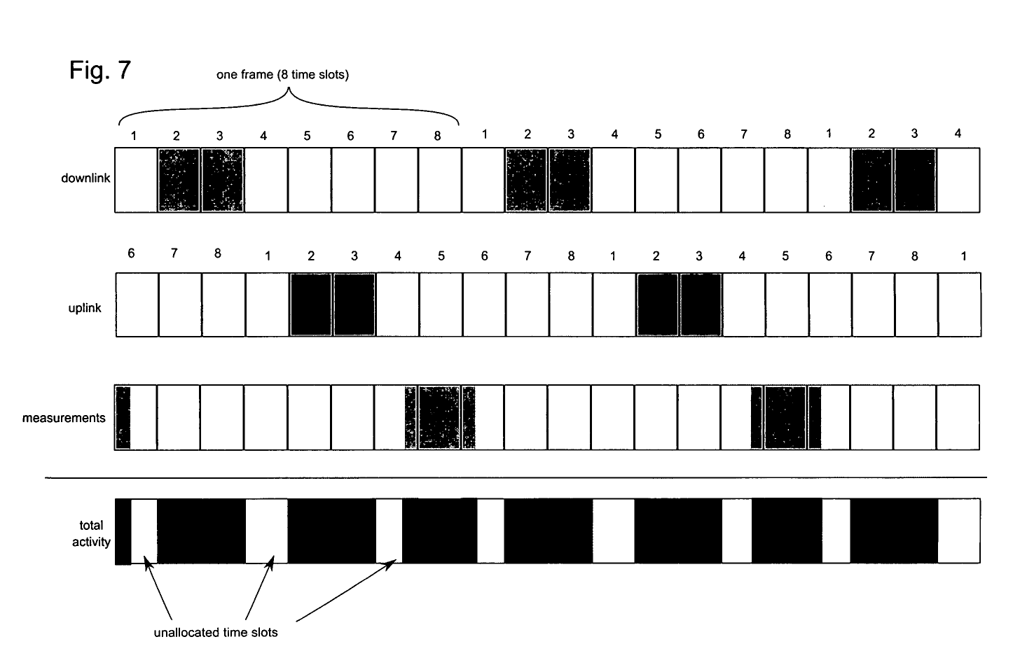

In a system that employs TDMA (such as GSM or GPRS), another embodiment of the invention may be applied. Typically, certain time slots of a channel are allocated for transmission or reception of data at the uplink and downlink frequency bands, as illustrated in FIG. 7. In the example shown, downlink time slots 2 and 3 and uplink time slots 2 and 3 are allocated for data transmission. In each frame, measurements are performed by listening to signals on other frequencies, e.g. for handover purposes. Hence, basically all communication operations are carried out in slotted manner with defined timing, i.e. well-defined the start and end time of data communication bursts. Any time slots that are not allocated for data transmission, control related transmissions, or the like, could be used for positioning measurements on different frequencies. This is easily seen from the illustration of total activity in FIG. 7. Any free time slots shown as white blocks may be used for other purposes. Thus, a first signal may be transmitted on a first frequency, such as a signal in time slots allocated for uplink communication, in step 118 of FIG. 4. When a free time slot is available, the mobile terminal may tune to a different frequency as described above and transmit a second signal on a second frequency in step 120. If the mobile terminal 2 is capable of transmitting on more than two frequencies, further unallocated time slots may be used to transmit further signals on other frequencies. The signal transmission may be controlled such that only idle periods of a predefined minimum length are used for transmitting on a different frequency.

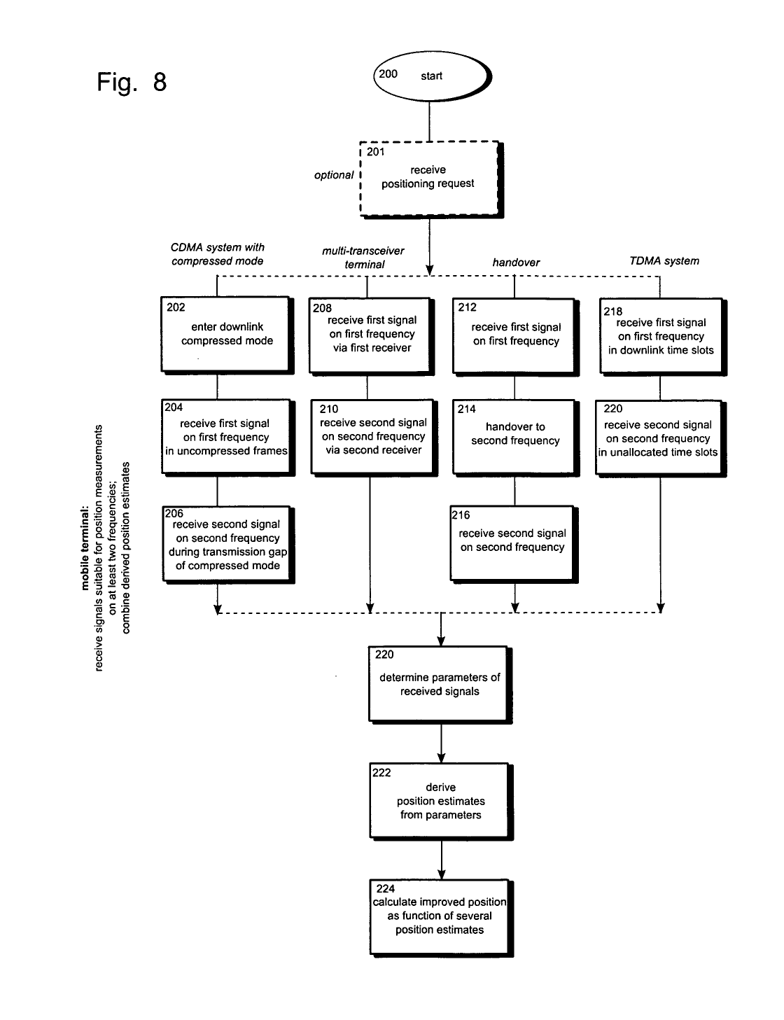

All examples described above relate to a remote positioning scheme, where the position of the mobile terminal is derived by monitoring signals transmitted from the mobile terminal 2 at several remote locations 4 as shown in FIG. 3a. However, the inventive idea may similarly be applied to a self-positioning system, that is, to positioning schemes where the mobile terminal 2 itself receives signals from several sources 4 on different frequencies and evaluates the received signals for positioning purposes. This is illustrated in FIG. 3b, and a corresponding flow chart including possible method steps is shown in FIG. 8. The mobile terminal may employ signals on different frequencies that are received during normal operation from base stations 4 of one or more networks and determine its position by any self-positioning technique based on parameters of these signals. All derived positions may then be averaged by the mobile terminal to obtain an averaged position value with improved accuracy. Such a self-positioning procedure may be requested by the network, and results may subsequently reported back to the network or used by the mobile terminal itself. Optionally, the averaging functionality may not be included in the mobile terminal, but again in some other network element. In this case, a mobile terminal may be requested to derive several position estimates (step 222 of FIG. 8) or only respective measurement values from received signals (step 220) on at least two different frequencies, and then transfer these results to a base station and/or a network controller for averaging and further processing. This might be suitable for more complicated positioning and averaging algorithms, or to include information about the network and signals into the averaging process.

The provisions for enabling positioning measurements on different frequencies in a self-positioning scheme would be similar to those of a remote positioning scheme as described in detail above. The signals received by the mobile terminal at different frequencies may for example be received in a downlink compressed mode, as in steps 202 to 206. Alternatively, the mobile terminal may have more than one receiver unit with one or more antennas to receive signals of several frequencies at the same time, represented by steps 208 and 210 of FIG. 8. Similar to the remote positioning scheme, also handovers or TDMA features may be used to derive position estimates on at least two frequencies. The mobile terminal may then in step 220 determine suitable parameters of the received signals and derive corresponding position estimates from these parameters in step 222. From these position estimates on different frequencies, the mobile terminal may then calculate an improved position value as a function of several position estimates by using a suitable algorithm, for example by averaging all estimates. Alternatively, the parameters or position estimates could be transmitted to another network element for deriving positions, as mentioned above. The optional step 210 of receiving a positioning request may not only be present in this embodiment, but in any of the inventive embodiments.

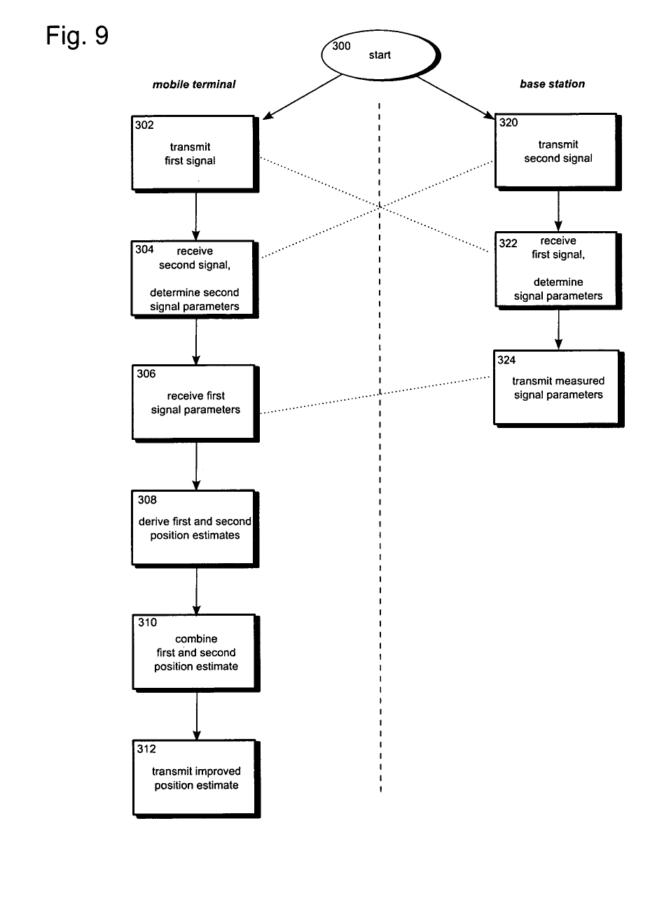

An exemplary embodiment of a further method according to the invention is illustrated in FIG. 3c, and the corresponding method steps are shown in FIG. 9. As also remote and self-positioning methods may be combined for the average, it is possible that in a further embodiment the mobile terminal transmits a first signal on a first frequency (step 302 of FIG. 9) and receives one or more second signals on a second frequency in step 304, which were transmitted by one or more base stations. The mobile terminal may then transmit its measurement results obtained from the second signal to a central site, where also the results of measurements of the first signal from several receivers are collected. The position may be derived from the respective measurements either at the central site or, at least in part, at the mobile terminal before transmitting the results to the central site. Following this, all derived positions from different frequency measurements are averaged or combined by any other algorithm or function. Optionally, the mobile terminal may in step 306 be provided with the measuring results based on the first signal it had transmitted on the first frequency and subsequently in step 310 combine (average) these results or the respective position estimate with the position estimate derived in step 308 from the received second signal. The combined and thus improved position value may then be used by the mobile station itself or transmitted to some remote network element, such as the base stations, in optional step 312. The order of steps is not intended to be strict; also, first and second signals could be exchanged. Furthermore, a first position estimate could optionally be derived by the mobile terminal before the second signal parameters are received in step 306, or the second signal could be received by the mobile terminal before transmitting the first signal. Transmitted signals on both sides may be specific positioning signals, but alternatively also normally occurring signalling between the network elements may be used to derive single position estimates. If the base station is able to determine a remote position on its own, e.g. by a positioning method based on only one fixed transceiver as described above in connection with FIG. 2d, it may determine a position estimate and transmit this estimate to the mobile terminal for averaging in step 324, instead of transmitting signal parameters.

Since many systems, such as GSM and WCDMA, employ frequency division duplex (FDD) mode for separating uplink and downlink signals, this would allow to obtain positioning estimates on different frequencies without any change of frequency. A position estimate derived from parameters of a downlink signal from base transceiver station to mobile terminal would inherently be performed on a different frequency than a second position estimate derived from parameters of an uplink signal from the mobile terminal 2 to the base stations 4, and thus these two position estimates may be used to calculate an averaged position value with improved accuracy. As mentioned, it is not important which network element finally receives the second position estimate and performs the averaging. The embodiment may be implemented in both directions. As shown in FIG. 3c, both parties that are involved in the position estimating process may provide their results to a third network element, which may again be a special location service unit 60, a network controller 6, a switching center 8 or the like.

Although many examples shown and described within this specification and corresponding figures are directed to an average of two position estimates on two different frequencies, the invention is not limited to averages from only two frequencies. A mobile terminal may be able to perform measurements at more than two frequencies, either simultaneously or sequentially. In that case, position estimates from more than two frequencies may be combined in a similar way as with only two estimates to obtain even higher accuracy. In addition, more than one measurement may be made on one of the used frequencies, such that an average may be formed of three or more position determinations taken on two frequencies.

The position information obtained by a self-positioning mobile terminal does not necessarily need to be sent back to the network. It could also be transferred to some other location via data communication to activate certain services, or it could be used for applications that are stored and executed on the mobile terminal, such as a locally stored city map. Similarly, the information obtained by averaging several position estimates at a central site of a network or at a base station in a remote positioning scheme may then be processed at any network element that requires position information, which may include the mobile terminal itself.

Weighted averages may be employed to account for certain known errors or effects, such that a positioning method that is known to provide more precise results may have more impact on the averaged position estimate. The weighting of each position estimate could also be based on the available signal quality at a certain frequency or the number of measurements/measured parameters that is available for deriving the respective estimate. In all embodiments, any functions or algorithms could in general be used instead of averaging for deriving an improved position estimate. The single position estimates derived on at least two frequencies and/or the measured signal parameters measured on at least two frequencies would be used as inputs for the respective functions or algorithms. Further inputs could be included.

All types of averaged and/or combined positioning as described above may either be performed on request from any element of the network, such as the mobile terminal itself or a network controller, or may also be performed at predefined intervals to provide regular position information. Position estimates or measurement values may be buffered or stored at the network element where it is derived or received for further processing or for future transfer to some other network element.

The foregoing description of representative embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising
establishing a radio link between a mobile terminal and at least one fixed transceiver of a cellular network;
acquiring at least two position estimates for the current position of said mobile terminal on at least two different frequencies; and
calculating an averaged position value from said at least two position estimates.

2. The method of claim 1, wherein said acquiring of a position estimate includes receiving at least one position estimate via said radio link.

3. The method of claim 1, wherein said acquiring of a position estimate includes:
receiving at least one signal on at least one frequency, and
determining one or more parameters of said at least one received signals.

4. The method of claim 3, wherein said acquiring of a position estimate further includes calculating a distance between said mobile terminal and said at least one transceiver based on said parameters.

5. The method of claim 1, wherein said acquiring of position estimates includes:
said mobile terminal receiving a first signal on a first frequency;
said mobile terminal performing a handover from said first frequency to a second frequency; and
said mobile terminal receiving a second signal on said second frequency.

6. The method of claim 5, wherein said handover is an inter-frequency handover.

7. The method of claim 5, wherein said handover is an inter-operator handover.

8. The method of claim 5, wherein said handover is an inter-mode handover.

9. The method of claim 5, wherein said handover is an inter-radio access technology handover.

10. The method of claim 5, wherein signals are received on more than two different frequencies, further comprising performing at least two subsequent handovers.

11. The method of claim 1, wherein a code division multiple access system is used for said radio link, and wherein said acquiring of position estimates includes:
said mobile terminal entering compressed mode;
said mobile terminal receiving a first signal on said first frequency; and
said mobile terminal receiving at least one second signal in at least one transmission gap on said second frequency.

12. The method of claim 1, wherein a time division multiple access scheme is used for said radio link, and wherein said acquiring of position estimates includes:
receiving a first signal on a first frequency in an time slot allocated for signal reception; and
receiving at least one second signal on a second frequency in an unallocated time slot.

13. The method of claim 3, wherein said mobile terminal has at least two receivers, and wherein said mobile terminal receives at least two signals on at least two different frequencies essentially simultaneously via said two receivers.

14. The method of claim 1, wherein said averaged position value is calculated using a weighted average.

15. A method comprising:
establishing a radio link between a mobile terminal and at least one fixed transceiver of a cellular network;
transmitting a first signal suitable for position measurements on a first frequency; and
transmitting a second signal suitable for position measurements on a second frequency.

16. The method of claim 15, further comprising transmitting at least one further signal suitable for position measurements on at least one further frequency.

17. The method of claim 15, wherein said mobile terminal performs said steps of transmitting a first and second signal, further comprising said mobile terminal performing a handover from said first frequency to said second frequency upon transmitting said first signal.

18. The method of claim 17, wherein said handover is an inter-frequency handover.

19. The method of claim 17, wherein said handover is an inter-operator handover.

20. The method of claim 17, wherein said handover is an inter-mode handover.

21. The method of claim 17, wherein said handover is an inter-radio access technology handover.

22. The method of claim 17, wherein signals are transmitted on more than two different frequencies, further comprising performing at least two subsequent handovers between at least three frequencies.

23. The method of claim 15, wherein a code division multiple access system is used for said radio link, and wherein said mobile terminal performs said steps of transmitting first and second signals, further comprising:
said mobile terminal entering compressed mode;
and wherein said mobile terminal transmits said at least one second signal in at least one transmission gap on said second frequency.

24. The method of claim 15, wherein a time division multiple access scheme is used for said radio link, and wherein:
said first signal is transmitted in an time slot allocated for signal transmission; and
said at least one second signal is transmitted in an unallocated time slot.

25. A method comprising:
establishing a radio link between a mobile terminal and at least one fixed transceiver of a cellular network;
transmitting a first signal suitable for position measurements on a first frequency;
receiving a second signal suitable for position measurements on a second frequency; and
deriving a second position estimate from measured parameters of said second signal.

26. The method of claim 25, further comprising transmitting said second position estimate.

27. The method of claim 25, further comprising receiving at least one position estimate based on said transmitted first signal.

28. The method of claim 27, further comprising calculating an averaged position estimate from said second position estimate and said at least one received position estimate.

29. The method of claim 25, wherein a code division multiple access system is used for said radio link, further comprising:
entering compressed mode for said radio link, and
transmitting or receiving said first or second signal during a transmission gap of said compressed mode.

30. The method of claim 25, wherein a time division multiple access scheme is used for said radio link, and wherein said first or second signal is received or transmitted in an unallocated time slot.

31. The method of claim 25, wherein a frequency division duplex mode is employed for uplink and downlink communication on said radio link.

32. The method of claim 28, wherein a frequency division duplex mode is employed for uplink and downlink communication on said radio link.

33. An apparatus comprising:
at least one radio communication unit adapted to acquire a first position estimate on a first frequency and a second position estimate on a second frequency, and
a processor connected to said at least one radio communication unit and configured to calculate a combined position value as a function of said position estimates.

34. The apparatus of claim 33, wherein said radio communication unit includes an antenna subsystem capable of transmitting and receiving signals on at least two different frequencies.

35. The apparatus of claim 34, further comprising a controller connected to said radio communication unit and configured to select a operating frequency for said radio communication subsystem.

36. The apparatus of claim 33, wherein said processor is further configured to determine a current position value for said apparatus based on signals received via said radio communication unit.

37. The apparatus of claim 33, wherein said apparatus is a mobile communication terminal.

38. The apparatus of claim 33, wherein said apparatus is a base transceiver station.

39. The apparatus of claim 33, wherein said apparatus is a network controller.

40. A device comprising:
means for acquiring a first position estimate on a first frequency;
means for acquiring a second position estimate on a second frequency; and
means for calculating a combined position value as a function of said position estimates.

41. A system comprising:
at least one base transceiver station of a cellular network;
a mobile terminal adapted for transmitting and/or receiving signals on at least two different frequencies; and
a processor adapted to determine a position based on measured signal parameters, and to calculate an combined position value as a function of at least two position estimates.

42. The system of claim 36, wherein said processor is located at one of the group of: a network controller, a mobile switching center, a base station controller.

43. The system of claim 36, wherein said processor is included in said mobile terminal.

44. The system of claim 36, wherein said processor is included in one of said base transceiver stations.

45. The system of claim 36, wherein said mobile terminal is a dual mode terminal capable of operating in a CDMA based system and a TDMA based system.
